(19) United States
(12) Patent Application Publication
(10) Pub. No.: US 2012/0276458 A1
(43) Pub. Date: Nov. 1, 2012

(54) NANOFIBER ELECTRODES FOR ENERGY STORAGE DEVICES

(75) Inventors: Betar M. Gallant, Cambridge, MA (US); Yang Shao-Horn, Cambridge, MA (US); Carl V. Thompson, II, Acton, MA (US); Robert R. Mitchell, III, Cambridge, MA (US)

(73) Assignee: MASSACHUSETTS INSTITUTE OF TECHNOLOGY, Cambridge, MA (US)

(21) Appl. No.: 13/097,244

(22) Filed: Apr. 29, 2011

(51) Int. Cl. H01M 12/06; H01M 4/04; H01M 4/02; B32B 5/02; H01G 9/04; B05D 5/12; B32B 3/26; B82Y 30/00; B82Y 99/00; B82Y 40/00

(52) U.S. Cl. 429/405; 429/402; 427/77; 427/78; 428/304.4; 428/316.6; 428/292.1; 361/532; 977/948; 977/762

(57) ABSTRACT

Methods and devices for enhanced energy storage in an electrochemical cell are provided. In some embodiments, an electrode for use in a metal-air electrochemical cell can include a plurality of nanofiber (NF) structures having high porosity, tunable mass, and tunable thickness. The NF structures are particularly suited for energy storage and can provide the electrode with exceptionally high gravimetric capacity and energy density when used in an electrochemical cell.

### STATEMENT REGARDING U.S. GOVERNMENT RIGHTS

This invention was made with U.S. government support under Grant No. DMR-0819762, awarded by the National Science Foundation (NSF). The U.S. Government has certain rights in the invention.

### FIELD OF THE APPLICATION

The present application relates generally to electrochemical technology and, in particular, to electrodes for electrochemical cells, including air-breathing batteries, metal-air batteries, fuel cells, and capacitors.

### BACKGROUND OF THE APPLICATION

Demand continues to grow for lighter and longer lasting power sources for consumer electronic devices, such as laptop computers, cell phones and other hand held instruments. Likewise, hybrid-electric and all-electric vehicles increasingly need rechargeable batteries with higher energy and capacities to increase the range of such vehicles for a fixed battery mass or volume. One of the most promising technologies to meet these needs lies in metal-air electrochemical cells. In metal-air batteries, a metal containing compound such as lithium metal, lithiated carbon, or lithiated silicon forms the negative electrode. Positively-charged metal cations from the negative electrode migrate through an electrolyte to an oxygen/air permeable porous positive electrode to form oxygen-containing compounds such as oxides, hydroxides, or carbonates during discharge. The cation migration in the electrochemical cell is associated with flow of electrons through an external load from the negative electrode to the positive electrode, which generates electrical work.

Metal-air batteries have much higher energy densities than conventional lithium ion batteries. In particular, lithium-air batteries can potentially reach over three-fold greater gravimetric energy density than lithium-ion batteries in a fully-packed cell level. During discharge of a lithium-air battery for example, oxygen is reduced by lithium ions to form lithium (per)oxides via:

2Li⁺+2e⁻+O₂ [symbol] (Li₂O₂)_{solid} Eᵣₑᵥ=2.96 V_{Li}

4Li⁺+4e⁻+O₂ [symbol] 2(Li₂O)_{solid} Eᵣₑᵥ=2.91 V_{Li},

where V_{Li} is the standard Li/Li⁺ electropotential value. As well, the use of an air-based positive electrode can lower battery weight, and potentially boost the gravimetric energy density (battery energy output normalized to battery mass) of batteries, which is of particular importance in a number of applications such as increasing electric vehicle distance range between charging events.

Li-air batteries face substantial challenges that currently limit their practical applications, including large voltage hysteresis and low round-trip efficiency between discharge and charge, low gravimetric and volumetric power, and short cycle life (typically below 100 cycles). While Li—O₂ gravimetric energy in the discharged state (normalized by mass of carbon and Li₂O₂) extrapolated from studies to date are up to ˜4 times higher than those of lithium-ion battery positive electrodes such as LiCoO₂ (˜600 Wh/kg_{electrode}), they fall short of the theoretical gravimetric energy for Li₂O₂ filling the entire electrode volume, calculated as ˜3215 Wh/kg_{Li2O2} assuming a practical discharge voltage of 2.75 V vs. Li. During discharge, the flow of oxygen and electrolyte through highly tortuous pathways in the positive electrode can become blocked as Li₂Oₓ forms on the carbon surface, limiting the electrode capacity.

Accordingly, a need exits to provide techniques and methods that can address this challenge, and to boost the performance of metal-air batteries and electrochemical cells.

### SUMMARY OF THE INVENTION

In one aspect, an electrochemical cell is provided having a positive electrode, a negative electrode, and an electrolyte. The positive electrode can include a porous substrate having a plurality of nanofibers disposed thereon. In some embodiments, the nanofibers can be aligned. In other embodiments, the nanofibers can include carbon nanofibers. The negative electrode can consist exclusively of a metal, such as lithium, or a metal storage compound, such as silicon (forming LiₓSi during charging). The nanofibers can have a void volume of at least about 80%, and the positive electrode can have a gravimetric energy greater than about 500 Wh/kg_{electrode}, where the term “electrode” refers to the total mass of electro active material within a fully discharged positive electrode, including carbon and discharge products such as lithium peroxide or lithium oxide, and may also include the mass of catalyst contained within an electrode. The positive electrode can also include a conductive element in the form of a metal layer disposed between the porous substrate and the nanofibers. While the conductive layer can take many forms, it can generally be a metal, usually a refractory metal, such as tantalum, tungsten, palladium, or nickel. The porous substrate can also be formed of any suitable material, for example, alumina. In addition, the nanofibers can be configured to provide the positive electrode with a gravimetric capacity greater than about 200 mAh/g_{electrode}.

In another aspect, an electrochemical cell having a positive electrode, a negative electrode, and an electrolyte is provided having a positive electrode comprising a plurality of nanofibers having a void volume greater than about 80%. In some embodiments, the nanofibers can include carbon and/or can be formed on a porous substrate. The negative electrode can consist exclusively of a metal, such as lithium, or a metal storage compound, such as silicon (forming LiₓSi during charging). The positive electrode can have a gravimetric energy greater than about 500 Wh/kg_{electrode}. The positive electrode can also include a conductive element in the form of a metal layer disposed between a porous substrate and the nanofibers. While the conductive layer can take many forms, it can generally be a metal, usually a refractory metal, such as tantalum, tungsten, palladium, or nickel. The porous substrate can also be formed of any suitable material, for example, alumina. In addition, the nanofibers can be configured to provide the positive electrode with a gravimetric capacity greater than about 200 mAh/g_{electrode}.

In still a further aspect, an electrochemical cell is provided having a positive electrode, a negative electrode, and an electrolyte. The positive electrode can include a plurality of aligned nanofibers. In one embodiment, the nanofibers can include carbon nanofibers. The negative electrode can consist exclusively of a metal, such as lithium, or a metal storage compound, such as silicon (forming LiₓSi during charging). In some embodiments, the cell can also include a porous substrate, the nanofibers being disposed on the porous substrate. The nanofibers can have a void volume greater than about 80%, and the positive electrode can have a gravimetric energy greater than about 500 Wh/kg_{electrode}. The positive electrode can also include a conductive element in the form of a metal layer disposed between the porous substrate and the nanofibers. While the conductive layer can take many forms, it can generally be a metal, usually a refractory metal, such as tantalum, tungsten, palladium, or nickel. The porous substrate can also be formed of any suitable material, for example, alumina. In addition, the nanofibers can be configured to provide the positive electrode with a gravimetric capacity greater than about 200 mAh/g_{electrode}.

In another aspect, an electrochemical cell having a positive electrode, a negative electrode, and an electrolyte is provided and can include a positive electrode having nanofibers and a gravimetric energy greater than about 500 Wh/kg_{electrode} and a gravimetric capacity great than about 200 mAh/g_{electrode}. In other embodiments, the positive electrode can have a gravimetric energy greater than about 1000 Wh/kg_{electrode} and/or a gravimetric capacity greater than about 400 mAh/g_{electrode}. In some embodiments, the positive electrode can include a plurality of carbon nanofibers having a void volume greater than about 80%. The negative electrode can consist exclusively of a metal, such as lithium, or a metal storage compound, such as silicon (forming LiₓSi during charging). The positive electrode can also include a conductive element in the form of a metal layer disposed between a porous substrate and the nanofibers. While the conductive layer can take many forms, it can generally be a metal, usually a refractory metal, such as tantalum, tungsten, palladium, or nickel. The porous substrate can also be formed of any suitable material, for example, alumina.

In one aspect, the present invention discloses improved electrodes for use in metal-air electrochemical cells. An exemplary electrochemical cell can have a positive electrode, a negative electrode, and an electrolyte, and the improvement can include a positive electrode having a porous substrate with a plurality of carbon nanofibers extending from an electrolyte-contacting surface of the substrate and configured to provide the positive electrode with a gravimetric capacity greater than about 200 mAh/g_{electrode}. In some embodiments, the electrochemical cell can further include a metal-air electrochemical cell. The cell can also include a conductive element in the form of a metal layer disposed between the porous substrate and the carbon nanofibers. While the conductive layer can take many forms, it can generally be a metal, usually a refractory metal, such as tantalum, tungsten, palladium, or nickel. The porous substrate can also be formed of any suitable material, for example, alumina.

In one embodiment, the carbon nanofibers can have a void volume greater than about 80%. In addition, the carbon nanofibers can be configured to provide the positive electrode with a gravimetric capacity greater than about 200 mAh/g_{electrode}. The carbon nanofibers can generally extend from the substrate to contact the electrolyte, and the positive electrode can be configured to oxidize at least one metal-oxide species during charging. The carbon nanofibers can be formed without a binder, and they can have any thickness extending from the substrate as desired, for example about 4 micrometers, 5 micrometers, 6 micrometers, 7 micrometers, etc.

In another aspect, methods of making an electrode for use in an electrochemical cell are provided and can include providing a porous substrate, depositing a layer of a catalyst on a first surface of the porous substrate, and synthesizing a plurality of nanofibers on the layer of the catalyst. The method can further include depositing a conductive layer between the first surface of the porous substrate and the layer of the catalyst for providing an electrically conductive path to the nanofibers. In some embodiments, the nanofibers can be carbon nanofibers and/or they can be synthesized using chemical vapor deposition.

Synthesizing the plurality of nanofibers can include synthesizing the nanofibers to obtain a void volume of greater than about 80%. In an exemplary embodiment, the nanofibers can have a gravimetric capacity of greater than about 200 mAh/g_{electrode} when discharged in an electrochemical cell. The metal-air electrochemical cell can be made without using a binder.

In a further aspect, a method of operating a metal-air electrochemical cell having a negative electrode and a porous positive electrode in an electrolyte is provided and the method can include providing a plurality of nanofibers on the porous positive electrode in contact with the electrolyte, exposing the porous positive electrode and the nanofibers to oxygen to induce migration of metal cations from the negative electrode to the positive electrode, and extracting electrons from the negative electrode. The method can also include recharging the cell by injecting electrons into the negative electrode to cause disassociation of the oxides at the positive electrode and return migration of positively charged metal ions to the reconstitute elemental metal at the negative electrode. In some embodiments, the negative electrode can include a lithium metal or lithium containing (for example, LiₓSi) negative electrode. The nanofibers can optionally be carbon nanofibers and in some embodiments, can have a gravimetric capacity of greater than about 200 mAh/g_{electrode}.

### BRIEF DESCRIPTION OF THE DRAWINGS

Aspects of the present invention will be more fully understood from the following detailed description taken in conjunction with the accompanying drawings (not necessarily drawn to scale), in which:

FIG. 1 is a schematic representation of an exemplary electrode for use in an electrochemical cell having a plurality of carbon nanofibers (CNFs) formed thereon;

FIG. 1A is perspective view of an exemplary porous substrate used for supporting the CNFs;

FIG. 1B is a perspective view of the substrate of FIG. 1A having a refractory metal layer for conduction and a catalyst metal layer for growing the CNFs formed thereon;

FIG. 1C is a perspective view of the substrate of the FIG. 1D having a plurality of CNFs extending therefrom;

FIG. 2 is a schematic representation of the electrode of FIGS. 1A-1D utilized in an electrochemical cell;

FIG. 2A is a schematic representation of a metal-air battery during discharge;

FIG. 2B is a schematic representation of a metal-air battery during charge;

FIG. 3A is a scanning electron microscope (SEM) micrograph of a magnified exemplary porous substrate before the formation of CNFs thereon;

FIG. 3B is a SEM micrograph of the substrate of FIG. 3A having a plurality of CNFs formed thereon;

FIG. 4A is a schematic representation of exemplary CNFs formed on a porous substrate and exposed to oxygen and electrolyte in an electrochemical cell;

FIG. 4B is a schematic representation of the CNFs and the substrate of FIG. 4A during discharge of the electrochemical cell showing the formation of Li₂Oₓ on the CNFs;

FIG. 5A is a SEM micrograph of a magnified exemplary electrode showing the formation of Li₂Oₓ on the CNFs during discharge of the electrochemical cell;

FIG. 5B is a further magnified image of FIG. 5A;

FIG. 6A is a graph showing the galvanostatic discharge and charge at about 40 mA/g_{carbon} depicting average performance results;

FIG. 6B is a graph showing the galvanostatic discharge and charge at about 130 mA/g_{carbon} depicting best performance results;

FIG. 7A is a graph showing the decomposition potentials of the electrolyte on an exemplary CNF electrodes in electrochemical cells purged with oxygen and argon gas;

FIG. 7B is a graph showing the galvanostatic discharge capacity of an Al₂O₃—Ta—Fe substrate (no carbon) in oxygen with a lower cutoff voltage of 2.0 V_{Li} shown with the galvanostatic performance of an exemplary Al₂O₃—Ta—Fe—CNF electrode in oxygen and in argon;

FIG. 8 is a graph showing an x-ray diffraction scan of an exemplary Al₂O₃—Ta—Fe—CNF electrode following galvanostatic discharge in an electrochemical cell indicating Li₂O₂ is formed during discharge when compared with an as-synthesized electrode that was not electrochemically tested;

FIG. 9A is a graph showing the average performance galvanostatic rate capability (capacities normalized to carbon mass) of exemplary aligned CNF electrodes under a range of gravimetric currents with a 2.0 V_{Li} cutoff potential;

FIG. 9B is a graph showing the best performance galvanostatic rate capability (capacities normalized to carbon mass) of exemplary aligned CNF electrodes under a range of gravimetric currents with a 2.0 V_{Li} cutoff potential;

FIG. 9C is a graph showing the average performance galvanostatic rate capability (capacities normalized to discharged electrode mass, including masses of carbon and lithium peroxide) of exemplary aligned CNF electrodes under a range of gravimetric currents with a 2.0 V_{Li} cutoff potential;

FIG. 10 is a graph showing the cyclic voltammetry of aligned CNF electrodes as positive electrodes in a lithium cell at a scan rate of 1 mV/s;

FIG. 11 is a graph illustrating gravimetric power versus gravimetric energy for CNF electrodes;

FIG. 12 is a graph illustrating the cycling performance of CNF electrodes;

FIG. 13A is a schematic illustration of an electrochemical capacitor employing CNF electrodes according to another aspect of the invention; and

FIG. 13B is a schematic illustration of another electrochemical capacitor employing CNF electrodes according to another aspect of the invention.

### DETAILED DESCRIPTION

Certain exemplary embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention.

The present invention generally provides methods and devices for enhanced energy storage in an electrochemical cell, and in particular in a metal-air electrochemical cell. In some embodiments, an electrode of a metal-air electrochemical cell can include a plurality of nanofiber (NF) structures having high porosity, tunable mass, and tunable thickness. The NF structures are particularly suited for energy storage and can provide the electrode with exceptionally high gravimetric capacity and energy density compared to other carbon-based electrodes. Methods for making and using such an electrode are also provided.

Unless otherwise specified, the following terms will be accorded the meanings disclosed below. As utilized herein, the term “air” refers to an electrochemical cell that utilizes oxygen at the positive electrode for an electrochemical reaction. Accordingly, the oxygen can be air, but can also be any other fluid that includes molecular oxygen.

As utilized herein, the phrase “metal-air” when describing electrochemical cells refers to such cells where oxygen is utilized at the positive electrode of the cell. Metals useful as the negative electrode in metal-air electrochemical cells include not only lithium but also other alkali metals, such as sodium and potassium, as well as similar compositions, such as zinc, aluminum, and carbon in some applications. In addition, the term encompasses metal containing materials, including non-metallic materials, such as silicon, having atomic metal species contained and/or dispersed therein.

The term “nanofiber” as used herein refers to nanostructures that include nanofibers, nanotubes (single and/or multi-walled structures), nanofilaments, nanoribbons, etc. The nanofibers can be formed from any suitable material, including but not limited to, carbon, silicon, or the like.

The term “tunable” as used herein when describing the characteristics of the nanofibers (NFs) disposed on an electrode refers to the adjustability of these characteristics based on how the NFs are synthesized and/or grown. For example, the phrases “tunable mass” and/or “tunable thickness” of the NFs simply refers to the ability to control the mass and/or thickness of the NFs through, for example, the catalyst metal, the temperature, and/or the ambient gases used during a chemical vapor deposition process utilized for synthesizing the NFs.

As used herein, the term “aligned” when referring to NFs generally means that the NFs extend relative to one another in a single direction. For example, if a substrate is utilized with the NFs, the NFs can extend in a direction that is substantially perpendicular to the substrate, parallel to the substrate, and/or at any angle relative to the substrate. In some instances, at least one end of the NFs can be attached to the substrate. If a substrate is not utilized with the NFs, the NFs can generally all extend in the same direction relative to one another. In all cases, while the NFs extend in a single direction, they can be substantially straight, curled, curved, helical, etc.

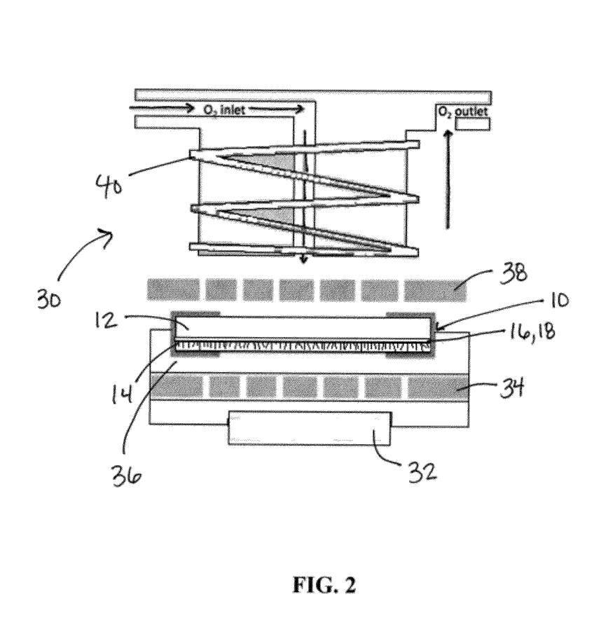

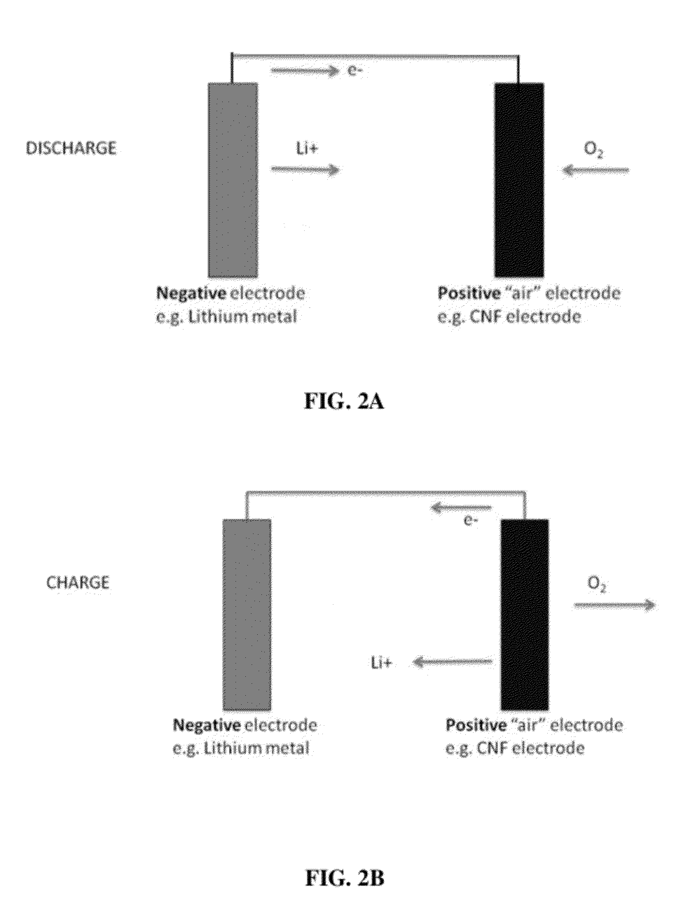

The phrase “positive electrode” will be used to characterize the NF electrode that is exposed to oxygen/air. The term “negative electrode” will be used to characterize the metal electrode that will donate metal ions during discharge. These terms are indicated most clearly in FIGS. 2A and 2B.

The term “g_{electrode}” refers to the total mass of electroactive material within a fully discharged positive electrode, including carbon and discharge products such as lithium peroxide or lithium oxide, and may also include the mass of catalyst contained within an electrode.

Finally, the phrase “electrochemical oxidation” will be used to refer to when the neutral metal atom (e.g., Li contained in Li₂O₂ at the positive electrode) is ionized to become a Li⁺ ion and an electron during charge of the metal-air battery. Further, the phrase “electrochemical reduction” refers to the reverse process when Li⁺ ions migrating from the metal-containing negative electrode react with O₂ at the positive electrode to become Li₂O₂ during discharge.

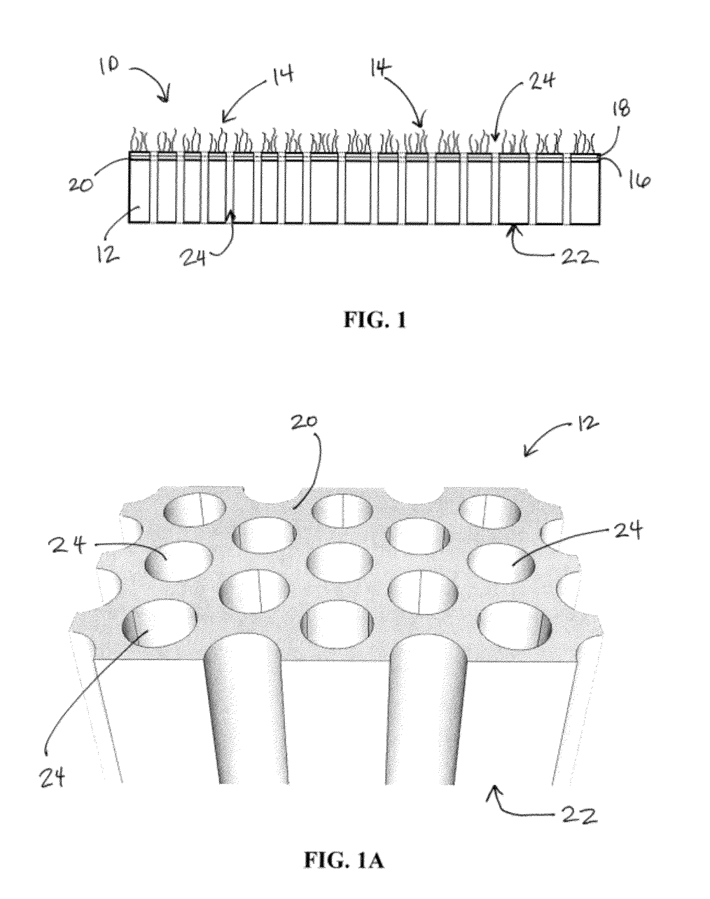

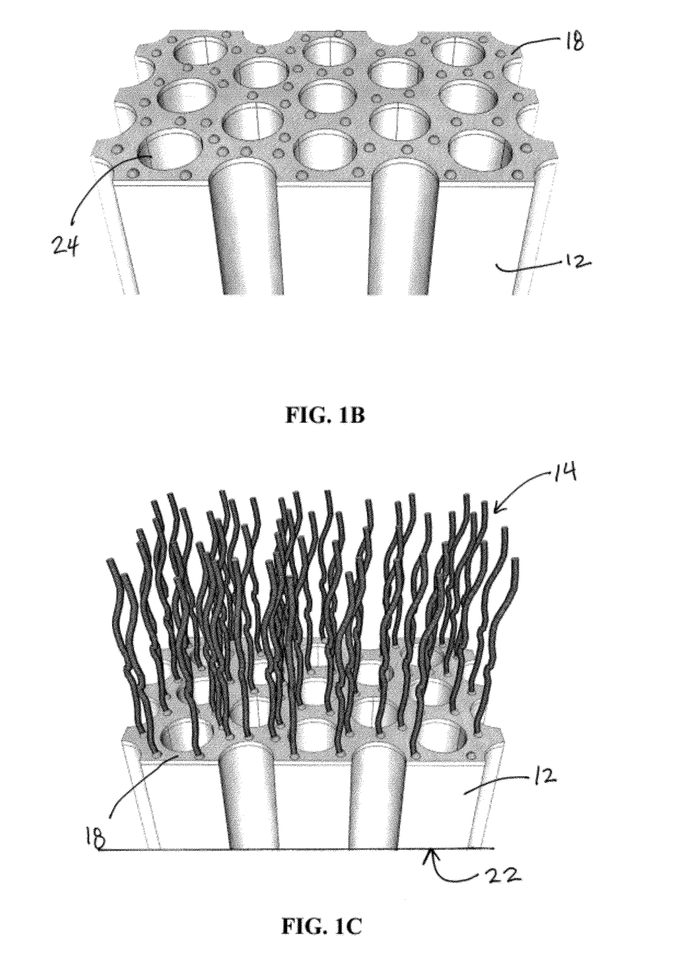

Some embodiments of the invention are directed to an electrode for use in an electrochemical cell that can exhibit enhanced performance. A schematic of an exemplary electrode 10 is shown in FIG. 1. In the illustrated embodiment, the electrode 10 can be formed from a porous substrate 12 having a plurality of NFs, for example, carbon nanofibers (CNFs) 14, extending therefrom. The NFs can be synthesized onto the substrate or separately formed and then transferred to the substrate. In some embodiments, the electrode 10 can also include a layer of a catalyst metal to assist in synthesizing the CNFs 14 and/or a conductive layer, typically a metal, to assist in electrical conduction. For example, a layer of a metal, usually a refractory metal, can be disposed on a first surface 20 of the substrate 12 as a conductive layer 16, and a catalyst layer 18 can be disposed on top of the conductive layer 16. The CNFs 14 can extend from the catalyst layer 18 in a generally aligned configuration as described in more detail below.

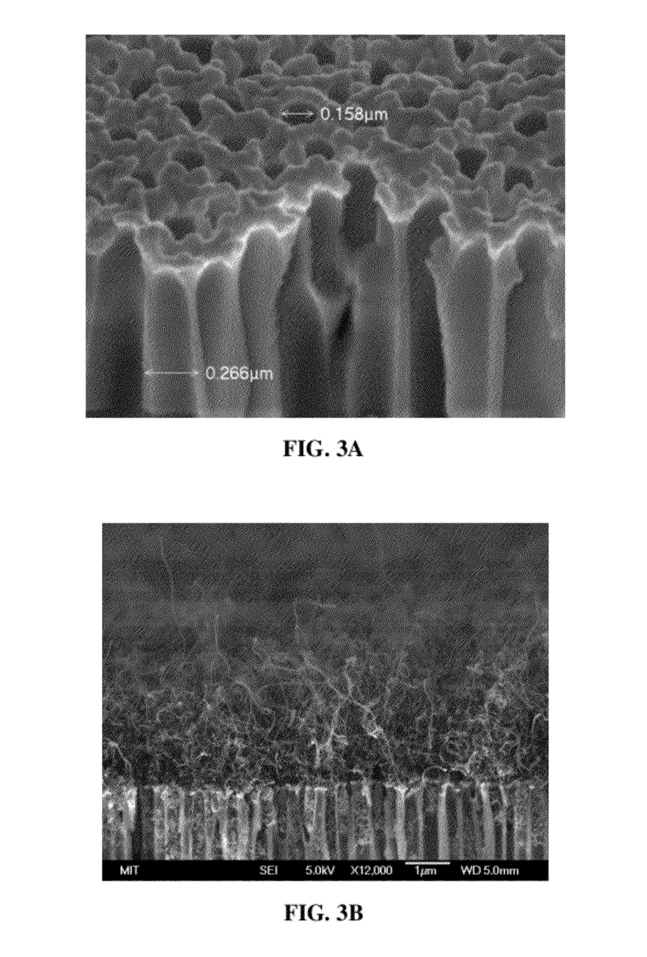

An exemplary process for forming the electrode 10 is illustrated in more detail in FIGS. 1A-1C. While a porous substrate for use in the electrode 10 can take many forms, including any conductive material and/or partially, substantially, and/or completely nonconductive material known in the art, in the illustrated embodiment, the porous substrate 12 is in the form of an aluminum oxide filter block, as shown in FIGS. 1A and 3A. Other exemplary porous substrates include, but are not limited to, carbon paper, carbon cloth, metal mesh, metal screen, alumina fiber mesh, etc, and/or solid substrates having perforations formed thereon by known chemical, mechanical, and/or electrical means. In addition, the pores in a porous substrate need not be linear, nor do they need to be orthogonal to the plane of the substrate. The pores can be linear extending any direction within the substrate, and/or the pores can be tortuous throughout the substrate. It will also be appreciated that in some embodiments, a substrate is not required in forming a NF or CNF electrode. In this case, the substrate 12 can have a plurality of pores 24 extending between its first surface 20 and its second surface 22. The substrate 12 can also have any dimensions as desired. For example, the substrate 12 can have a thickness (i.e., the distance between the first surface 20 and the second surface 22) in a range of about 1 μm to about 1 mm, about 10 μm to about 1 mm, about 20 μm to about 1 mm, about 50 μm to about 1 mm, about 100 μm to about 1 mm, about 200 μm to about 1 mm, about 300 μm to about 1 mm, about 400 μm to about 1 mm, about 500 μm to about 1 mm, about 600 μm to about 1 mm, about 700 μm to about 1 mm, about 800 μm to about 1 mm, about 900 μm to about 1 mm, about 1 μm to about 900 μm, about 1 μm to about 800 μm, about 1 μm to about 700 μm, about 1 μm to about 600 μm, about 1 μm to about 500 μm, about 1 μm to about 400 μm, about 1 μm to about 300 μm, about 1 μm to about 200 μm, about 1 μm to about 100 μm, about 1 μm to about 50 μm, about 1 μm to about 20 μm, about 1 μm to about 10 μm, and/or about 40 μm, 50 μm, 60 μm, 70 μm, 80 μm, 90 μm, 100 μm, etc. In the embodiment illustrated in FIGS. 1A-1C, the substrate 12 has a thickness of about 60 μm. The substrate can likewise have a pore size in a range of about 1 nm to about 5 μm, about 10 nm to about 5 μm, about 50 nm to about 5 μm, about 100 nm to about 5 μm, about 500 nm to about 5 μm, about 1 μm to about 5 μm, about 1.5 μm to about 5 μm, about 2 μm to about 5 μm, about 2.5 μm to about 5 μm, about 3 μm to about 5 μm, about 3.5 μm to about 5 μm, about 4 μm to about 5 μm, about 4.5 μm to about 5 μm, about 1 nm to about 4.5 μm, about 1 nm to about 4 μm, about 1 nm to about 3.5 μm, about 1 nm to about 3 μm, about 1 nm to about 2.5 μm, about 1 nm to about 2 μm, about 1 nm to about 1.5 μm, about 1 nm to about 1 μm, about 1 nm to about 500 nm, about 1 nm to about 100 nm, about 1 nm to about 50 nm, about 1 nm to about 10 nm, and/or about 10 nm, about 20 nm, about 30 nm, about 40 nm, about 50 nm, about 60 nm, about 70 nm, etc. In the illustrated embodiment, the substrate 12 has a pore size of about 20 nm.

As shown in FIGS. 1 and 1B, the two metal layers 16, 18 can be disposed on the first surface 20 of the substrate 12. While any suitable metal can be used as the conductive layer 16 and the catalyst layer 18 respectively, in the illustrated embodiment, a Ta film is disposed on the surface 20 as the conductive layer 16 and a Fe film is deposited on top of the Ta film as the catalyst layer 18. It will be appreciated that any metal having limited and/or minimal reactivity with the catalyst layer 18 can be used as the conductive layer 16, including but not limited to W, Ti, Mo, Cr, Pd, Ni, Pt, and Al can be used as the conductive layer 16. The two films can be disposed on the surface 20 using, for example, an e-beam evaporation system, a sputter deposition system, a thermal evaporation system, and/or an electrodeposition system, to provide any desired thickness. In the illustrated embodiment, the Ta film has a thickness of about 30 nm and the Fe film has thickness of about 2 nm. It will be appreciated that each of the Ta film and the Fe film can have any desired thickness in the range of about 0.1 nm to about 1 mm, depending on desired characteristics.

In some embodiments, the exemplary electrode 10 can also include an additional catalyst metal for promoting/catalyzing an electrochemical reaction when the electrode 10 is used in an electrochemical cell. Exemplary embodiments of such catalysts and associated methods for utilizing such catalysts can be found in U.S. Provisional Application No. 61/330,264, entitled “Catalysts for Oxygen Reduction and Evolution in Metal-Air Electrochemical Cells,” and filed on Apr. 30, 2010; U.S. Provisional Application No. 61/353,190, entitled “Catalysts for Promoting Chemical Reactions,” and filed on Jun. 9, 2010; and U.S. Provisional Application No. 61/397,453, entitled “Catalysts for Promoting Chemical Reactions,” and filed on Jun. 10, 2010, all of which are hereby incorporated by reference in their entireties. Other catalysts can include, but are not limited to, a nitrogen-doped surface of CNFs, Fe, Co, Ni, Pt, Au, MnO₂, Fe₂O₃, Fe₃O₄, NiO, Co₃O₄, and any combination thereof.

Once the appropriate catalyst and refractory metal layers are disposed on the porous substrate 12, a plurality of CNFs can be grown and/or synthesized on the substrate 12. CNFs, also referred to as “vapor grown” CNFs, are cylindrical nanostructures with graphitic layers arranged as stacked cones, cups, or plates that are formed on a substrate using a technique known as chemical vapor deposition (CVD). It will be appreciated by those having ordinary skill in the art that there are a number of conditions under which the CNFs can be synthesized in a CVD process, and that any process capable of producing the CNFs can be utilized. One exemplary process is described in more detail below in the Example section, and an exemplary result of such a process is shown in FIGS. 1C and 3B. In general, however, when the substrate 12 with the Fe catalyst layer 18 is exposed to high temperatures in a gaseous environment, gas-phase molecules decompose at the high temperatures and carbon is deposited in the presence of the metal catalyst. The CVD process can include gas decomposition, carbon deposition, fiber growth, fiber thickening, graphitization, and purification, resulting in a plurality of CNFs extending from the substrate 12.

The resulting synthesized CNFs 14 can be generally aligned with one another extending from the surface 20 of the substrate 12, and can have a void volume of at least about 80%. In some embodiments, the CNFs can have a void volume of greater than about 30%, about 40%, about 50%, about 60%, about 70%, about 80%, about 90%, about 95%, and/or about 99%. Low densities can advantageously be achieved through the formation of nanoparticle catalysts ex situ, followed by solution-based deposition of particles on the substrates. In addition, control of the concentration of particles in the solution can be used to decrease/increase the catalyst areal density resulting in low/high density growth. Further, by controlling the introduction of reducing gas during the CNF growth, the catalyst morphological evolution can be controlled, and in turn the areal density of the CNF carpet.

In addition, the length of the CNFs extending from the surface 20 of the substrate 12 can be in the range of about 500 nm to about 2 mm, about 1 μm to about 2 mm, about 50 μm to about 2 mm, about 100 μm to about 2 mm, about 500 μm to about 2 mm, about 1 mm to about 2 mm, about 1.5 mm to about 2 mm, about 500 nm to about 1.5 mm, about 500 nm to about 1 mm, about 500 nm to about 500 μm, about 500 nm to about 100 μm, about 500 nm to about 50 μm, about 500 nm to about 10 μm, about 500 nm to about 1 μm, for example about 5 μm, 6 μm, 7 μm, 8 μm, 9 μm, etc. In addition, each of the CNFs can have a diameter in a range of about 1 nm to about 500 nm, about 10 nm to about 500 nm, about 50 nm to about 500 nm, about 100 nm to about 500 nm, about 200 nm to about 500 nm, about 300 nm to about 500 nm, about 400 nm to about 500 nm, about 1 nm to about 400 nm, about 1 nm to about 300 nm, about 1 nm to about 200 nm, about 1 nm to about 100 nm, about 1 nm to about 50 nm, about 1 nm to about 10 nm, for example, 20 nm, 30 nm, 40 nm, 50 nm, 60 nm, 70 nm, 80 nm, 90 nm, 100 nm, etc. As will be appreciated by those having skill in the art, the void volume, mass, thickness, etc. of the plurality of CNFs, as well as the diameter, shape, and size of the individual CNFs, are tunable by varying the CVD process conditions such as temperature, reactant gas flow rate, and growth time.

A schematic of one particular embodiment of the exemplary electrode 10 used in an electrochemical cell 30 is shown in FIGS. 2-2B. In this embodiment, the electrode 10 is used as a positive electrode in a lithium-air battery, although it can be used with any metal-air electrochemical cell known in the art. The cell 30 can include a lithium foil negative electrode 32 which is utilized as the source of lithium ions, and can be disposed adjacent to a porous separator 34. An aprotic electrolyte 36 can be used between the Li negative electrode 32 and the positive electrode 10 and can contain any suitable electrolyte salt, for example LiClO4 in dimethoxyethane (DME) solvent. The cell 30 can have inlet and outlet valves to allow the flow of oxygen into and out of the chamber enclosing the various components of the electrochemical cell 30. The oxygen can flow through a porous spacer, separator 38, disposed adjacent to the electrode 10, through the porous substrate 12, and into contact with the CNFs 14 and the solvent 36. A spring 40 can act to compress and balance the various components of the cell 30 into contact with another during discharge and charging of the cell 30.

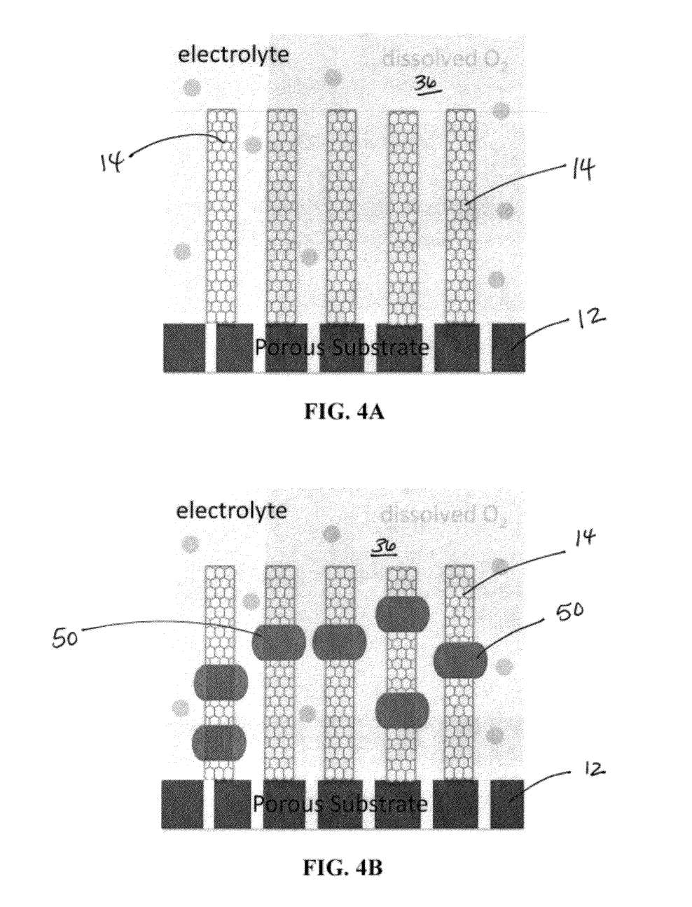

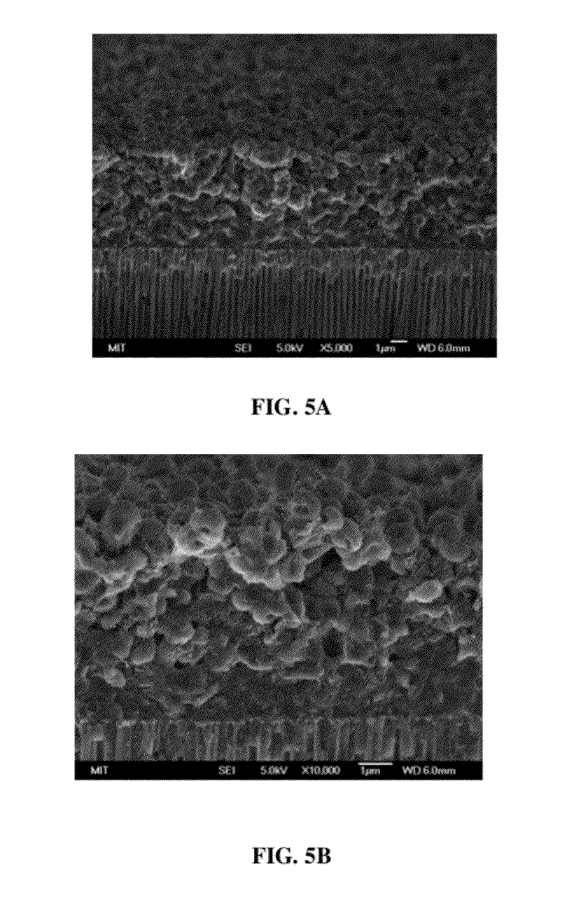

As will be appreciated by those having ordinary skill in the art, discharge of the cell 30 results in dissolution of the lithium metal at the foil 32, electrochemical reduction of oxygen, and deposition in the form of an oxide 50 (e.g., LiO₂, Li₂O, and/or Li₂O₂) within and on the CNFs 14, as shown in FIGS. 2A, 2B, 4A and 4B, to achieve the flow of electrons to the positive electrode. A discharged cell, showing the densely packed Li₂Oₓ species can be seen in FIGS. 5A and 5B. Charging of the cell 30 can result in electrochemical oxidation of one or more lithium oxide species 50. The NFs described herein can provide a battery and/or capacitor with exceptionally high gravimetric capacities, capacitances, and energy densities. The high void volume within the NFs and the low density of the NFs allows for extensive oxide deposition while allowing the free flow of oxygen through the positive electrode for further electrochemical reduction. In addition, conventional particle-based electrodes can be highly tortuous, which can limit the accessibility of electrolyte to available surface areas and/or can impede the displacement of electrolyte during Li₂Oₓ growth as electrolyte transport pathways become choked off during discharge. The well developed, aligned, and highly interconnected pore structure of the NFs disclosed herein is highly advantageous in providing ease of flow for the electrolyte.

Exemplary NF electrodes described herein can exhibit gravimetric capacities greater than those possible in conventional Li-air batteries. For example, an exemplary CNF electrode disclosed herein can exhibit gravimetric capacities greater than about 200 mAh/g_{carbon}, 300 mAh/g_{carbon}, 500 mAh/g_{carbon}, 1000 mAh/g_{carbon}, 2000 mAh/g_{carbon}, 3000 mAh/g_{carbon}, 4000 mAh/g_{carbon}, about 5000 mAh/g_{carbon}, about 6000 mAh g_{carbon}, about 7000 mAh g_{carbon}, about 8000 mAh g_{carbon}, about 9000 mAh g_{carbon}, and as high as 10,000 mAh/g_{carbon} under a gravimetric current of about 100 mA/g_{carbon}. In addition, when exposed to a much higher gravimetric current of 250 mA/g_{carbon}, the CNF electrodes still exhibit capacities as high as about 3,500 mAh/g_{carbon}.

Another advantage to the exemplary NF electrodes described herein is that they can be made without the use of a binder. Conventional electrodes require the addition of a polymeric, insulating binder material to improve mechanical integrity of the electrodes and ensure good electrical connection between particles. The NF electrodes disclosed herein can be used without a binder, thereby lowering the weight of the electrode and maximizing the accessible NF surface area exposed to electrolyte.

It is understood that while the electrochemical cell of FIGS. 2-2B embodies some aspects of the present invention, other configurations can also be utilized including those known to one skilled in the art. For instance, lithium foil need not be utilized as the negative electrode. Indeed, any suitable negative electrode can be utilized with the cell. In addition, NFs need not be formed from carbon, as noted above. As well, the configuration of the cell, including the separators and the electrolyte used, can all be changed and adjusted as known in the art.

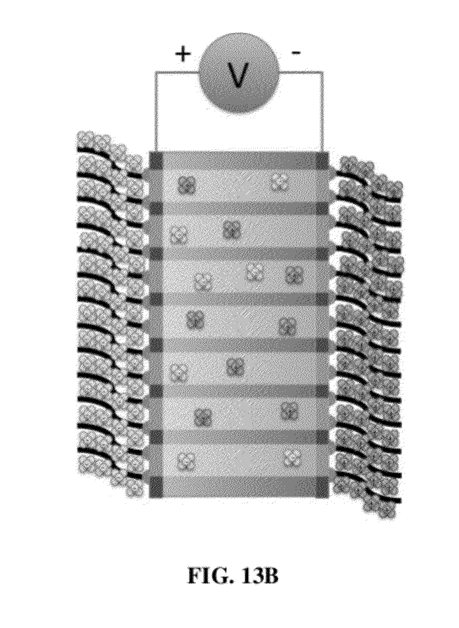

The NF electrodes disclosed herein can also be utilized in an exemplary electrochemical capacitor is shown in FIGS. 13A and 13B. This type of capacitor is referred to as an Electrochemical Double Layer Capacitor (EDLC). During operation, a potential is applied across the symmetric cells shown in FIGS. 13A and 13B, causing solvated anions and cations to form an ordered layer at the positive and negative electrodes, respectively. The charge separation at the electrolyte/electrode interface gives rise to the capacitor's energy storage capability.

### EXAMPLES

The following examples are provided to illustrate some embodiments of the invention. The examples are not intended to limit the scope of any particular embodiment(s) utilized.

In each of the experiments discussed below, a CNF electrode was utilized to test various aspects of the electrode itself and/or of the electrochemical cell that it is used in. Unless noted otherwise, the following components and procedures were used to prepare each of the CNF electrodes used in the various experiments, as well as its assembly into an electrochemical cell.

A plurality of CNF electrodes were prepared using Anopore Inorganic Membrane (Anodisc) substrates manufactured by Whatman® and having a 60 μm thickness and a 20 nm pore size. A 30 nm thick Ta film was applied to one side of each substrate using an e-beam evaporation system. A 2 nm thick Fe film was then applied on top of the Ta film, also using an e-beam evaporation system. CVD was then used to grow, deposit, and otherwise synthesize the CNFs on the Fe film catalyst. In particular, the prepared substrates were placed in a tube furnace at 700° C. in an ambient containing C₂H₄, H₂, and He gases. An exemplary substrate before synthesis of the CNFs can be seen in FIG. 3A, and after the synthesis of CNFs can be seen in FIG. 3B.

The aligned CNF electrodes were tested electrochemically as the air positive electrode in a lithium-air battery similar to the one illustrated in FIG. 2. A lithium metal negative electrode was used with two Celgard C480 separators. The cell was prepared using 140 μL of 0.1 M LiClO₄ electrolyte in DME solvent. The cell was assembled in an Argon-ambient glove box and was subsequently purged with O₂ gas and sealed for testing.

### Gravimetric Capacity

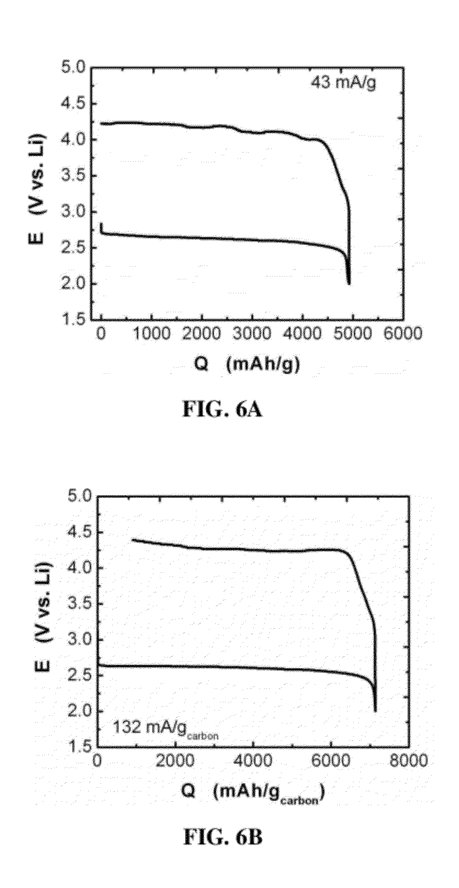

The performance of two CNF electrodes was measured under galvanostatic conditions at about 40 mA/g_{carbon} and about 130 mA/g_{carbon}. As shown in FIGS. 6A and 6B, the electrodes were capable of attaining very high gravimetric capacities of approximately 5,000-7,000 mAh/g_{carbon} at an average discharge voltage of about 2.6 V_{Li}. Additionally, the electrodes were cycled between 2.0 V_{Li} and 4.25 V_{Li} or 4.5 V_{Li}, showing that they were able to be recharged at a voltage of about 4.1 V_{Li}-4.2 V_{Li}.

### Decomposition Potential

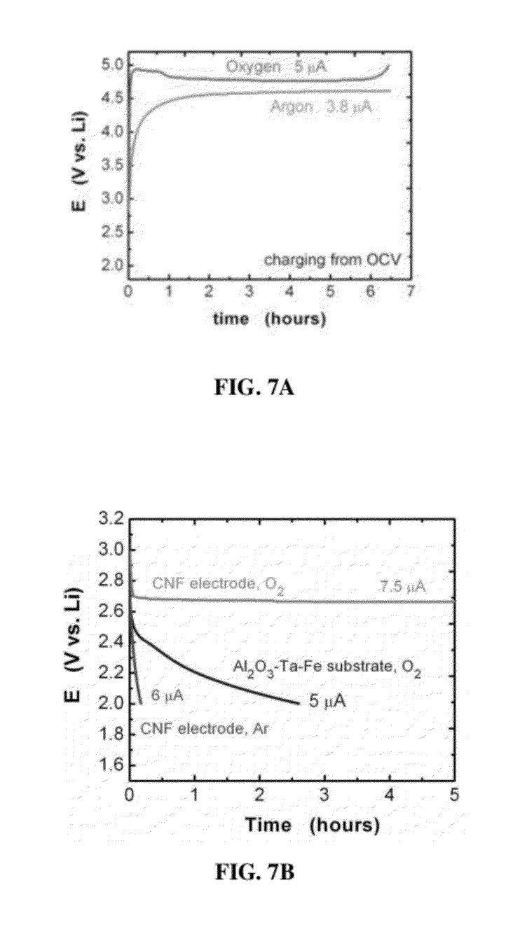

The decomposition potential of the electrolyte in cells containing CNF positive electrodes and Li metal negative electrodes was investigated in both oxygen gas and argon gas, as shown in FIG. 7A. This was done by galvanostatically charging the cell from open circuit voltage after each cell was assembled. As shown, the CNF electrode charged in oxygen resulted in an average charging voltage of about 4.7 V_{Li} with a current of 5 μA, while the CNF electrode charged in argon resulted in an average charging voltage of about 4.5 V_{Li} with a current of about 3.8 μA. Thus, it can be seen that the current achieved in FIG. 7A is a result of the dissolution of a Li₂O₂ species, and not the decomposition of the electrolyte.

### Effect of CNFs & Effect of Oxygen

An electrode was prepared using the same procedure as described above, however without synthesis of CNFs. In this way, an electrode with CNFs could be compared with an identical electrode without CNFs to investigate the effect the CNFs have on the discharge capacity of the electrode in oxygen. The results of this experiment are shown in FIG. 7B in which the electrodes were discharged to a lower cut-off voltage of about 2.0 V_{Li}. As shown, the electrode with no CNFs discharged in less than about 3 hours, while the electrode with the CNFs discharged over a time period greater than about 110 hours, indicating that the CNFs are indeed required to provide the electrode with increased discharge capacity.

A similar experiment was conducted testing the discharge capacity of an electrode having CNFs in argon gas, as also shown in FIG. 7B. The electrode discharged to the lower cut-off voltage of about 2.0 V_{Li} over a period less than one-half hour. This is a further indication that it is the combination of the CNFs with oxygen that is providing the electrode with its increased capacity.

### Discharge of Compounds

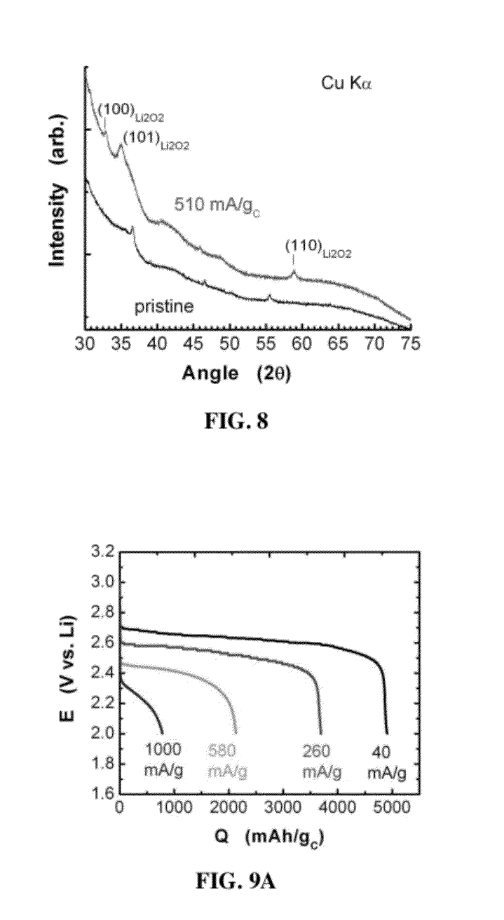

The high capacity of aligned CNF electrodes can be attributed primarily to the formation of Li₂O₂ within the electrode pores. This can be confirmed using X-Ray Diffraction (XRD) to compare a fully-discharged CNF electrode in oxygen with a pristine CNF electrode that was not tested electrochemically. The results of the XRD examination are shown in FIG. 8. As shown, the discharged electrode showed peaks indicative of Li₂O₂, while the pristine electrode lacked such peaks. An SEM image of a fully discharged electrode, shown in FIGS. 5A and 5B, reveals that micron-scale particles of LiₓOₓ had grown within the CNF structure, densely filling the pore volume. The porosity and three-dimensional, well-interconnected pore structure of the aligned CNF electrodes is a critical factor for enabling dense filling of LiₓOₓ and exceptionally high utilization of the available void volume and carbon mass.

### Gravimetric Currents

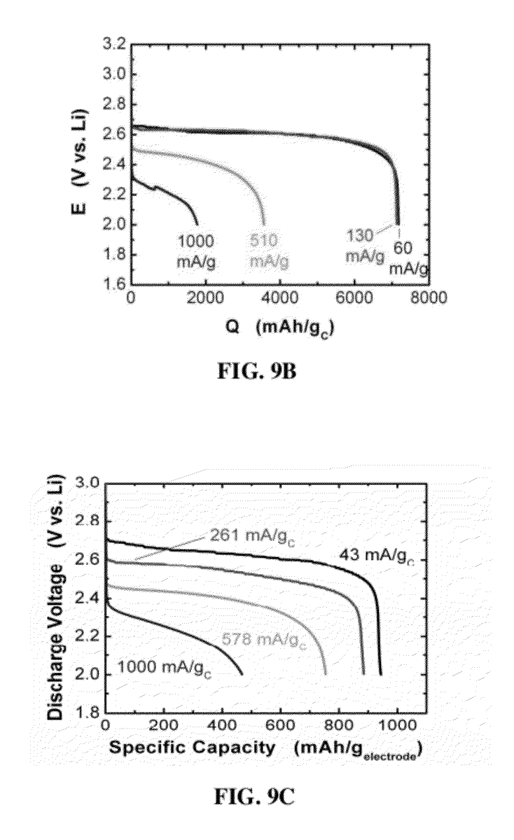

Four CNF electrodes were tested under four different gravimetric currents of 40 mA/g_{carbon}, 260 mA/g_{carbon}, 580 mA/g_{carbon} and 1000 mA/g_{carbon}, as shown in FIG. 9A. This experiment indicates that obtainable gravimetric capacities decrease at higher rates. Increasing the current from 400 mA/g_{carbon} to 260 mA/g_{carbon}, however, still results in an exceptionally high capacity of about 3700 mAh/g_{carbon}, as illustrated in FIG. 9A. FIG. 9B shows the best performance obtained from CNF electrodes, with a gravimetric capacity of about 7,100 mAh/g_{carbon} obtained at gravimetric currents up to 130 mA/g_{carbon}. The results shown in FIGS. 9A and 9B are normalized to the weight of carbon in the electrode. FIG. 9C illustrates the results of FIG. 9A normalized to the weight of carbon plus Li₂O₂ in the electrode upon discharge.

### Capacitor Applications

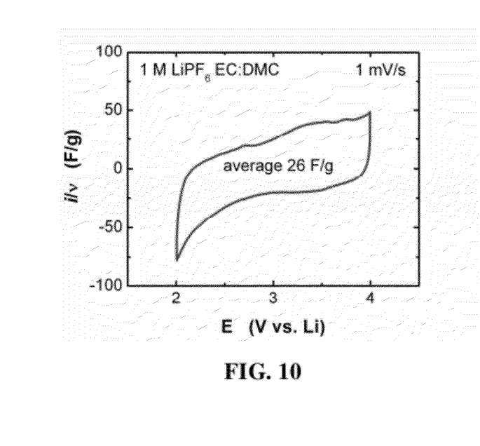

The aligned CNF electrodes were also tested for electrochemical capacitor applications in cells with a Li metal negative electrode, two Celgard 2500 separators, and 1 M LiPF₆ Li salt in EC:DMC (3:7 v/v) solvent. As shown in FIG. 10, cyclic voltammetry testing indicated that that the CNF electrodes have gravimetric capacitances averaging 26 F/g_{carbon} in the voltage window of about 2.0 V_{Li}-4.0 V_{Li}.

Gravimetric Power vs. Energy

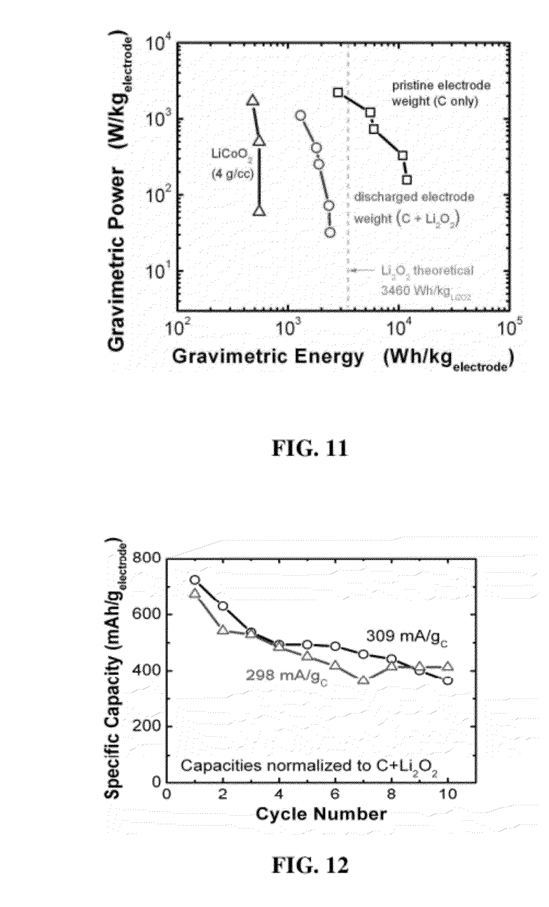

FIG. 11 is a plot of gravimetric power vs. gravimetric energy of CNF electrodes indicating that when normalized to weight of carbon only (representing the “best case” gravimetric performance), the CNF electrodes have gravimetric energies ranging from approximately 2500-12,000 Wh/kg_{C} at powers of 150-2400 W/kg_{C}. When normalized by the total weight of the discharged electrode (C+Li₂O₂), which represents the “worst-case” gravimetric performance (the CNF electrode is most massive upon discharge), CNF electrodes can store 1350-2500 Wh/kg_{C+Li2O2} at powers of 30-1100 W/kg_{C+Li2O2}, which represents a ˜4-fold improvement in energy compared to LiCoO₂ at comparable powers.

### Cycling Performance

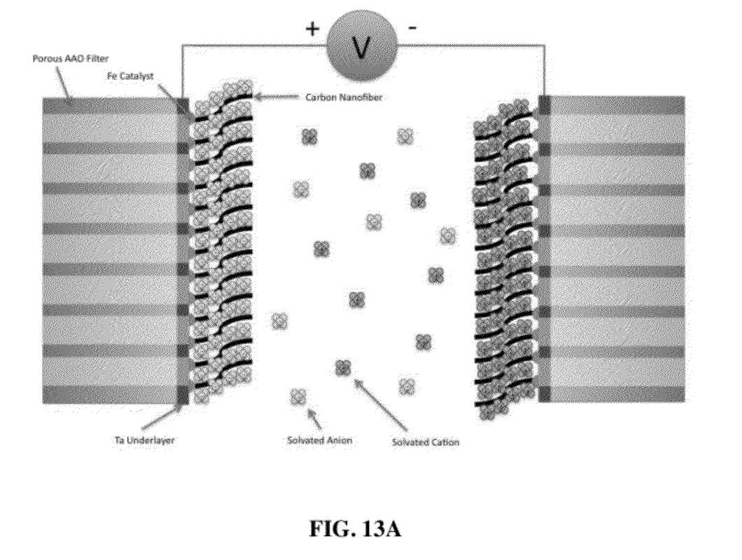

FIG. 12 illustrates two CNF electrodes that were cycled under galvanostatic conditions (˜300 mA/g_{C}) between the voltage range 2.0-4.5 V vs. Li. Considering the gravimetric capacity of CNF electrodes in the discharged state (C+Li₂O₂), CNF electrodes were found to retain ˜60% of capacity over 10 cycles.

While the present invention has been described in terms of specific methods, structures, and devices it is understood that variations and modifications will occur to those skilled in the art upon consideration of the present invention. As well, the features illustrated or described in connection with one embodiment may be combined with the features of other embodiments. Such modifications and variations are intended to be included within the scope of the present invention. Those skilled in the art will appreciate, or be able to ascertain using no more than routine experimentation, further features and advantages of the invention based on the above-described embodiments. Accordingly, the invention is not to be limited by what has been particularly shown and described, except as indicated by the appended claims. All publications and references are herein expressly incorporated by reference in their entirety.

What is claimed is:

1. In an electrochemical cell having a positive electrode, a negative electrode, and an electrolyte, the improvement comprising:
a positive electrode comprising a porous substrate having a plurality of nanofibers disposed thereon.

2. The cell of claim 1, wherein the plurality of nanofibers are aligned.

3. The cell of claim 1, wherein the plurality of nanofibers comprise carbon nanofibers.

4. The cell of claim 1, wherein at least a portion of the negative electrode comprises a metal.

5. The cell of claim 4, wherein the metal comprises lithium.

6. The cell of claim 1, wherein the negative electrode comprises a lithium storage compound.

7. The cell of claim 1, wherein the plurality of nanofibers have a void volume of at least about 80%.

8. The cell of claim 1, wherein the positive electrode further comprises a conductive element.

9. The cell of claim 8, wherein the conductive element comprises a metal layer disposed between the porous substrate and the nanofibers.

10. The cell of claim 9, wherein the metal layer comprises a refractory metal.

11. The cell of claim 10, wherein the refractory metal comprises one of tantalum, tungsten, palladium, and nickel.

12. The cell of claim 1, wherein the porous substrate is formed from alumina.

13. The cell of claim 1, wherein the positive electrode has a gravimetric energy greater than about 500 Wh/kg.

14. The cell of claim 1, wherein the nanofibers provide the electrode with a gravimetric capacity of greater than about 200 mAh/g_{electrode}.

15. In an electrochemical cell having a positive electrode, a negative electrode, and an electrolyte, the improvement comprising:
a positive electrode comprising a plurality of nanofibers having a void volume greater than about 80%.

16. The cell of claim 15, wherein the plurality of nanofibers comprise carbon nanofibers.

17. The cell of claim 15, further comprising a porous substrate, the plurality of nanofibers being formed on the porous substrate.

18. The cell of claim 15, wherein the plurality of nanofibers are substantially aligned.

19. The cell of claim 15, wherein at least a portion of the negative electrode comprises a metal.

20. The cell of claim 19, wherein the metal comprises lithium.

21. The cell of claim 15, wherein the positive electrode further comprises a conductive element.

22. The cell of claim 15, wherein the negative electrode comprises a lithium storage compound.

23. The cell of claim 21, wherein the conductive element comprises a metal layer disposed between a porous substrate and the nanofibers.

24. The cell of claim 23, wherein the metal layer comprises a refractory metal.

25. The cell of claim 24, wherein the refractory metal comprises one of tantalum, tungsten, palladium, and nickel.

26. The cell of claim 17, wherein the porous substrate is formed from alumina.

27. The cell of claim 15, wherein the positive electrode has a gravimetric energy greater than about 500 Wh/kg.

28. The cell of claim 15, wherein the nanofibers provide the electrode with a gravimetric capacity of greater than about 200 mAh/g_{electrode}.

29. In an electrochemical cell having a positive electrode, a negative electrode, and an electrolyte, the improvement comprising:
a positive electrode comprising a plurality of aligned nanofibers.

30. The cell of 29, wherein the plurality of nanofibers comprise carbon nanofibers.

31. The cell of claim 29, wherein at least a portion of the negative electrode comprises a metal.

32. The cell of claim 31, wherein the metal comprises lithium.

33. The cell of claim 29, further comprising a porous substrate, the nanofibers being disposed on the porous substrate.

34. The cell of claim 29, wherein the negative electrode comprises a lithium storage compound.

35. The cell of claim 29, wherein the positive electrode further comprises a conductive element.

36. The cell of claim 35, wherein the conductive element comprises a metal layer disposed between a porous substrate and the nanofibers.

37. The cell of claim 36, wherein the metal layer comprises a refractory metal.

38. The cell of claim 37, wherein the refractory metal comprises one of tantalum, tungsten, palladium, and nickel.

39. The cell of claim 36, wherein the porous substrate is formed from alumina.

40. The cell of claim 29, wherein the nanofibers have a void volume greater than about 80%.

41. The cell of claim 29, wherein the positive electrode has a gravimetric energy greater than about 500 Wh/kg.

42. The cell of claim 29, wherein the nanofibers provide the electrode with a gravimetric capacity of greater than about 200 mAh/g_{electrode}.

43. In an electrochemical cell having a positive electrode, a negative electrode, and an electrolyte, the improvement comprising:
a positive electrode comprising nanofibers and having a gravimetric energy greater than about 500 Wh/kg_{electrode} and a gravimetric capacity greater than about 200 mAh/g_{electrode}.

44. The cell of claim 43, wherein the positive electrode has a gravimetric capacity greater than about 400 mAh/g_{electrode}.

45. The cell of claim 43, wherein the positive electrode has a gravimetric energy greater than about 1000 Wh/kg_{electrode}.

46. The cell of claim 43, wherein the positive electrode comprises a plurality of carbon nanofibers.

47. The cell of claim 46, wherein the carbon nanofibers have a void volume greater than about 80%.

48. The cell of claim 43, wherein at least a portion of the negative electrode comprises a metal.

49. The cell of claim 48, wherein the metal comprises lithium.

50. The cell of claim 43, wherein the negative electrode comprises a lithium storage compound.

51. The cell of claim 43, wherein the positive electrode further comprises a conductive element.

52. The cell of claim 51, wherein the conductive element comprises a metal layer disposed between a porous substrate and the nanofibers.

53. The cell of claim 52, wherein the metal layer comprises a refractory metal.

54. The cell of claim 53, wherein the refractory metal comprises one of tantalum, tungsten, palladium, and nickel.

55. The cell of claim 52, wherein the porous substrate is formed from alumina.

56. In an electrochemical cell having a positive electrode, a negative electrode, and an electrolyte, the improvement comprising:
a positive electrode comprising a porous substrate having a plurality of carbon nanofibers extending from an electrolyte-contacting surface of the substrate and configured to provide the positive electrode with a gravimetric capacity greater than about 200 mAh/g_{electrode} and a gravimetric energy greater than about 500 Wh/kg_{electrode}.

57. The cell of claim 56, wherein the positive electrode further comprises a conductive element.

58. The cell of claim 57, wherein the conductive element comprises a metal layer disposed between the porous substrate and the carbon nanofibers.

59. The cell of claim 58, wherein the metal layer comprises a refractory metal.

60. The cell of claim 59, wherein the refractory metal comprises one of tantalum, tungsten, palladium, and nickel.

61. The cell of claim 56, wherein the porous substrate is formed from alumina.

62. The cell of claim 56, wherein the carbon nanofibers have a void volume greater than about 80%.

63. The cell of claim 56, wherein the carbon nanofibers are aligned.

64. The cell of claim 56, wherein the positive electrode does not include a binder.

65. The electrode of claim 56, wherein the carbon nanofibers have a thickness extending from the porous substrate of about 5 micrometers.

66. A method of making an electrode for use in a metal-air electrochemical cell, comprising:
providing a porous substrate; and
synthesizing a plurality of nanofibers on the porous substrate.

67. The method of claim 66, further comprising depositing a layer of a catalyst on a first surface of the porous substrate for synthesizing the plurality of nanofibers.

68. The method of claim 66, further comprising depositing a conductive layer between the first surface of the porous substrate and the layer of the catalyst for providing an electrically conductive path to the nanofibers.

69. The method of claim 66, wherein the nanofibers are synthesized using chemical vapor deposition.

70. The method of claim 66, wherein the nanofibers further comprise carbon.

71. The method of claim 66, wherein synthesizing the plurality of nanofibers includes synthesizing the plurality of nanofibers to obtain a void volume of greater than about 80%.

72. The method of claim 66, wherein the nanofibers provide the electrode with a gravimetric capacity of greater than about 200 mAh/g_{electrode}.

73. The method of claim 66, wherein the nanofibers provide the electrode with a gravimetric energy greater than about 500 Wh/kg_{electrode}.

74. The method of claim 66, wherein the metal-air electrochemical cell is made without using a binder.

75. A method of operating a metal-air electrochemical cell having a negative electrode and a positive electrode in an electrolyte, the method comprising:
providing a plurality of nanofibers on a porous substrate at the positive electrode in contact with the electrolyte;
exposing the positive electrode to oxygen;
inducing metal ion migration; and
extracting electrons from the negative electrode.

76. The method of claim 75, further comprising recharging the cell by injecting electrons into the negative electrode to cause disassociation of the oxides at the positive electrode and return migration of positively charged ions to the negative electrode.

77. The method of claim 75, wherein the negative electrode comprises a metal.

78. The method of claim 75, wherein the negative electrode comprises a lithium metal.

79. The method of claim 75, wherein the nanofibers comprise carbon.

80. The method of claim 75, wherein the nanofibers provide the positive electrode with a gravimetric capacity of greater than about 200 mAh/g_{electrode}.

81. The method of claim 75, wherein the nanofibers provide the positive electrode with a gravimetric energy of greater than about 500 Wh/kg_{electrode}.
